(19) United States
(12) Patent Application Publication
(10) Pub. No.: US 2024/0208790 A1
(43) Pub. Date: Jun. 27, 2024

(54) BEVERAGE DISPENSING APPARATUS AND SYSTEM

(71) Applicant: Kegland Holdings Pty Ltd, Noble Park North VIC (AU)

(72) Inventors: Phillip HIGGINS, Noble Park North VIC (AU); Kee DOERY, Noble Park North VIC (AU); Dominic EVANS, Clarinda VIC (AU)

(21) Appl. No.: 18/390,407

(22) Filed: Dec. 20, 2023

(30) Foreign Application Priority Data
Dec. 26, 2022 (AU) 2022904035

(51) Int. Cl. B67D 1/08

(52) U.S. Cl. CPC B67D 1/0852

(57) ABSTRACT

A beverage dispensing apparatus. The apparatus includes a body defining a beverage container receiving cavity. The apparatus includes a gas conduit and a beverage conduit, wherein at least one of the gas conduit and the beverage conduit comprise a piercing end disposed within the beverage container receiving cavity. The apparatus includes a beverage container fastener operable to fasten a beverage container when received in the beverage container receiving cavity.

### CROSS-REFERENCE TO RELATED APPLICATION

This application claims priority to Australian Patent Application 2022904035, filed Dec. 26, 2022, which is hereby incorporated by reference in its entirety.

### TECHNICAL FIELD

The disclosure herein generally relates to a beverage dispensing apparatus and a beverage dispensing system, and particularly but not exclusively to a dispensing apparatus for use with a disposable beverage container.

### BACKGROUND

Beverages, including but not limited to carbonated beverages, may be stored and transported in a pressure vessel in the form of a keg. In one example, beer is packaged in a metal keg at a brewery and the keg subsequently transported to a place where the beer is dispensed. Metal kegs are generally expensive and so generally must be returned to the brewery for reuse. Other examples of beverages that can be packaged in a pressure vessel include coffee, wine, kombucha or generally any suitable beverage.

A beverage can also be packaged in a one-way keg, which may comprise a plurality of polymers and a valve comprising rubber and a stainless-steel spring. One-way kegs are intended to make a one-way trip, and to be thrown away after the beverage is consumed—that is, they are disposable. One-way kegs are generally not refilled once emptied. One-way kegs may be considerably less expensive than metal kegs, which may be a requirement to make one-way kegs economical.

The valve is a significant proportion of the cost of a one-way keg. Consequently, small capacity one-way kegs may not be economically feasible. Most commercial one-way kegs have a capacity of at least 20 L.

One-way kegs are generally sent to land fill instead of being recycled. This may be because recyclers have difficulty separating and processing the plurality of polymers, the stainless-steel spring and the rubber.

It may be desired to have improved dispensing systems. It may be desired to reduce cost and improve recyclability, for example.

### SUMMARY

Disclosed herein is a beverage dispensing apparatus. The apparatus comprises a body defining a beverage container receiving cavity. The apparatus comprises a gas conduit and a beverage conduit, wherein at least one of the gas conduit and the beverage conduit comprise a piercing end disposed within the beverage container receiving cavity. The apparatus comprises a beverage container fastener comprising a fluid seal, the beverage container fastener being operable to sealingly fasten to a sealed beverage container when received in the beverage container receiving cavity.

In an embodiment, the beverage container fastener comprises a chuck for beverage container clamping. The chuck may comprise a movably mounted collet camming collar and a collet disposed therein.

An embodiment comprises a user operable piercing actuator operationally coupled to at least one piercing end. The user operable piercing actuator may comprise at least one lever. The user operable container piercing actuator may be operationally coupled to the collet camming collar. The user operable piercing actuator may comprise at least one collet camming collar engaging prong.

In an embodiment, the user operable piecing actuator is latchable.

In an embodiment, at least one piecing end is movable towards an opening of the beverage container receiving cavity. The at least one piecing end may be actuatably coupled to the user operable piercing actuator.

An embodiment has a first configuration ready to receive the beverage container and a second configuration for attaching the beverage container.

In an embodiment, the fluid seal comprises a fluid pressure seal.

In an embodiment, the fluid pressure seal is a planar fluid pressure seal.

In an embodiment, the fastener is operable to move the beverage container into the beverage container receiving cavity. The beverage container fastener may comprise a movably mounted jaw. The movably mounted jaw may be mounted to move at an inclined angle relative to the piercing end of each of the gas conduit and the beverage conduit. The movably mounted jaw may be mounted to a guide inclined relative to the at least one piercing end. The guide may comprise at least one pin.

In an embodiment, the centre to centre spacing of the gas conduit and the beverage conduit is in the range of 1 mm to 50 mm.

In an embodiment, the gas conduit and the beverage conduit extend equally into the beverage container receiving cavity.

An embodiment comprises a plurality of actuatable handles operationally coupled to the fastener.

Disclosed herein is a beverage dispensing system comprising the beverage dispensing apparatus in accordance with the above disclosure and the beverage container.

In an embodiment, the beverage container comprises a closure comprising a perimeter wall presenting a smooth outer surface.

In an embodiment, the beverage container comprises a tapered closure. The beverage container receiving cavity may be for the closure.

Disclosed herein is a beverage container comprising a closure comprising a perimeter wall presenting a smooth outer surface.

Disclosed herein is a method of dispensing a beverage. The method comprises sealingly fastening a beverage dispensing apparatus defined by any one of the claims 1 to 19 to a beverage container. The method comprises piercingly inserting the gas conduit and the beverage conduit into the beverage container without removal of the closure. The method may comprise

flowing a gas through the gas conduit.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 shows an isometric view of an embodiment of a beverage dispensing apparatus attached to a beverage container.

FIG. 2 shows a side elevation view of the apparatus of FIG. 1 in a first configuration, ready to receive the beverage container.

FIG. 3 corresponds to FIG. 1, with an example of the top of a suitable beverage container received by the apparatus of FIG. A1.

FIG. 4 shows a side elevation view of the apparatus of FIG. 1 in a second configuration.

FIG. 5 corresponds to FIG. 4, with the beverage container attached.

FIG. 6 is a cut away side elevation view corresponding to FIG. 2, showing the received beverage container closure but not the beverage container vessel.

FIG. 7 is a cut away side elevation view corresponding to FIG. 5, showing the beverage container vessel.

FIG. 8 shows an elevation cut away view of a neck and a closure of the beverage container.

FIGS. 9 to 11 show isometric, cut away and side elevation views of the beverage container of FIG. 8.

FIGS. 12 and 13 show different exploded isometric views corresponding to FIG. 1.

FIGS. 14 and 15 show elevation views of a beverage container fastener of the apparatus of FIG. 1 in the first configuration and the second configuration respectively.

FIG. 16 shows a plan view of a piercing actuator of the apparatus of FIG. 1.

FIG. 17 shows a plan view of a plunger of the apparatus of FIG. 1.

FIG. 18 shows a side elevation view of the plunger of FIG. 17.

FIG. 19 shows a cut away side elevation view of the plunger of FIG. 17.

FIG. 20 shows a detail of FIG. 19, and in particular a seal.

FIGS. 21 and 22 show side elevation views of the plunger of FIG. 17 pivotably mounted to the actuator of FIG. 16.

FIGS. 23 and 24 show bottom isometric views of the apparatus of FIG. 1 in the first and second configurations respectively.

FIGS. 25 and 26 show cutaway elevation views of another embodiment of a beverage dispensing apparatus in two different configurations.

FIG. 27 shows an exploded view of the apparatus of FIG. 25 and the beverage container to be received by the apparatus.

FIGS. 28 to 30 show various configurations of the apparatus of FIG. 25.

FIGS. 31 and 32 show isometric views of the apparatus of FIG. 25 and part of the beverage container received thereby.

FIG. 33 shows a sectional view of another embodiment, wherein a ring seal is disposed within a closure to form a seal.

### DESCRIPTION OF EMBODIMENTS

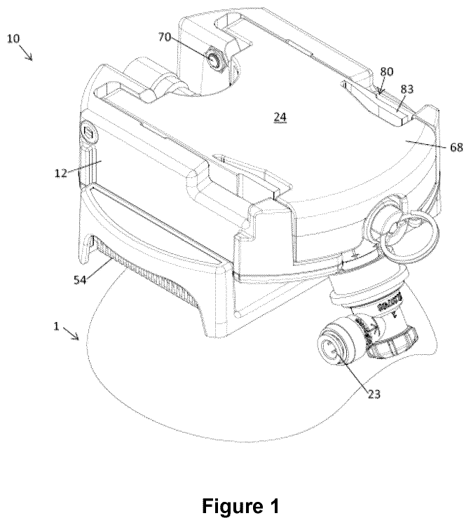

FIG. 1 shows an isometric view of an embodiment of a beverage dispensing apparatus attached to a beverage container, the apparatus being generally indicated by the numeral 10 and the beverage container by the numeral 1. The apparatus 10 is for dispensing a beverage in the sealed beverage container 1, an example of which is a beverage container in the form of a bottle, that can contain a carbonated and/or nitrogenated beverage. The bottle is generally but not necessarily provided with a pressurised beverage, for example beer, therein. Generally any suitable and desired beverage container may be used, however. An alternative embodiment is configured for a beverage can, drink can or beer can. Examples of suitable beverages that may be dispensed using apparatus 10 include but are not limited to beer, coffee, wine, kombucha or generally any suitable and desired beverage.

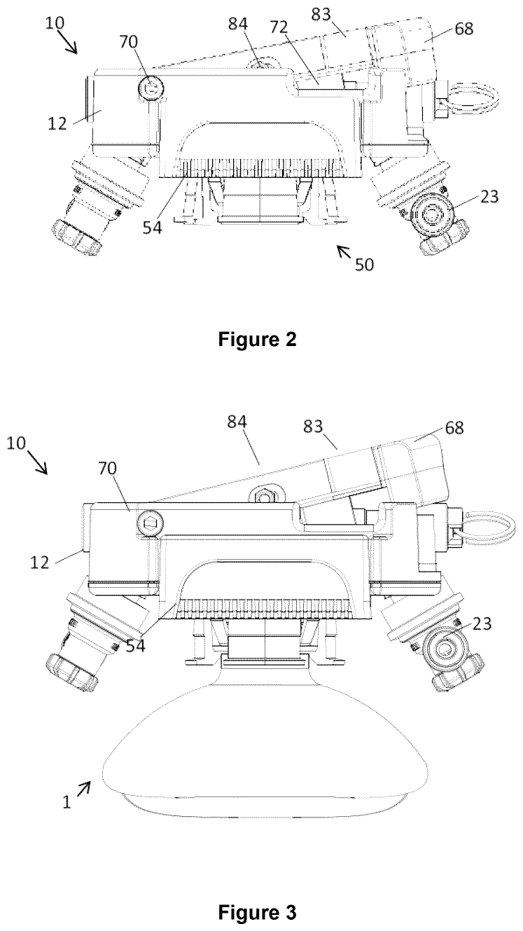

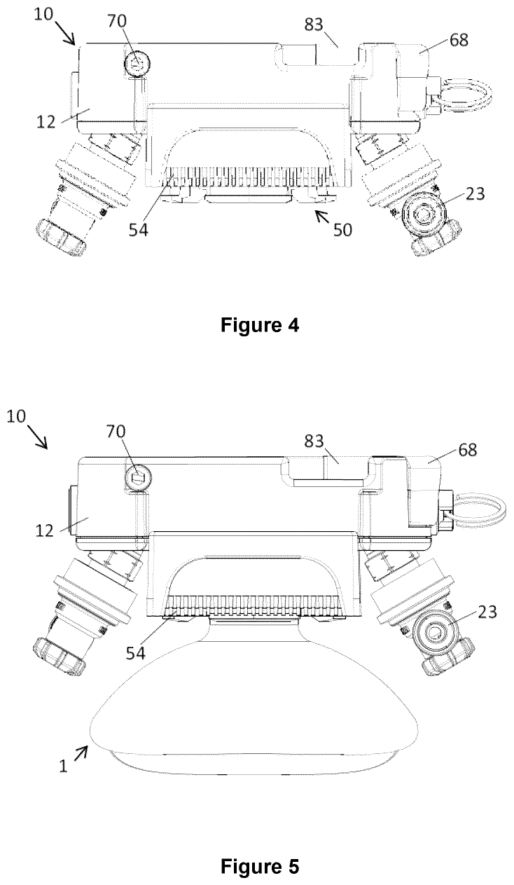

FIGS. 2 to 5 show various side elevation views of the apparatus 10 in various configurations, with and without the beverage container 1. In FIG. 2 the apparatus is shown in a first configuration in which the apparatus 10 is ready to receive the beverage container 1. FIG. 3 corresponds to FIG. 2, with the received beverage container 1. In FIG. 4, the apparatus 10 is shown in a second configuration. FIG. 5 corresponds to FIG. 4 with the apparatus 10 in the second configuration, and shows the beverage container 1 being received and attached. The apparatus 10 comprises a body 12. FIG. 7 shows a cut away elevation view, revealing that the body 12 defines a beverage container receiving cavity 14. The apparatus 10 can be used to dispense a beverage in the beverage container, when the beverage container is received by the beverage container receiving cavity 14.

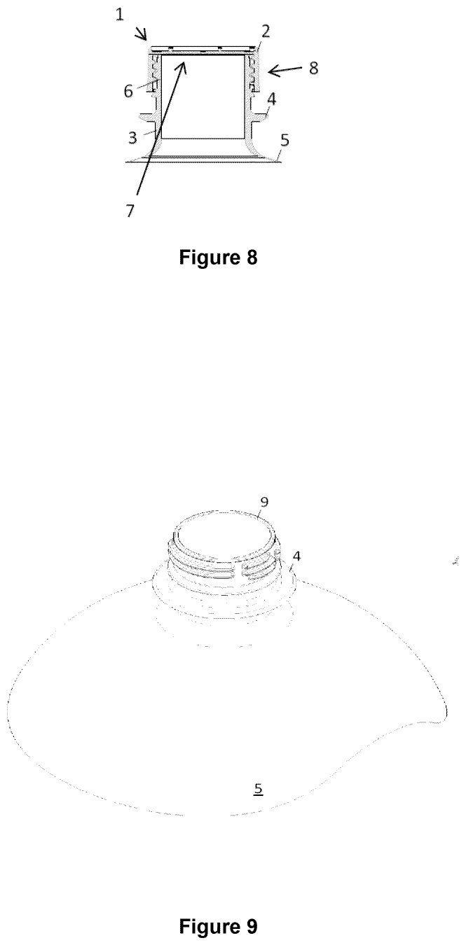

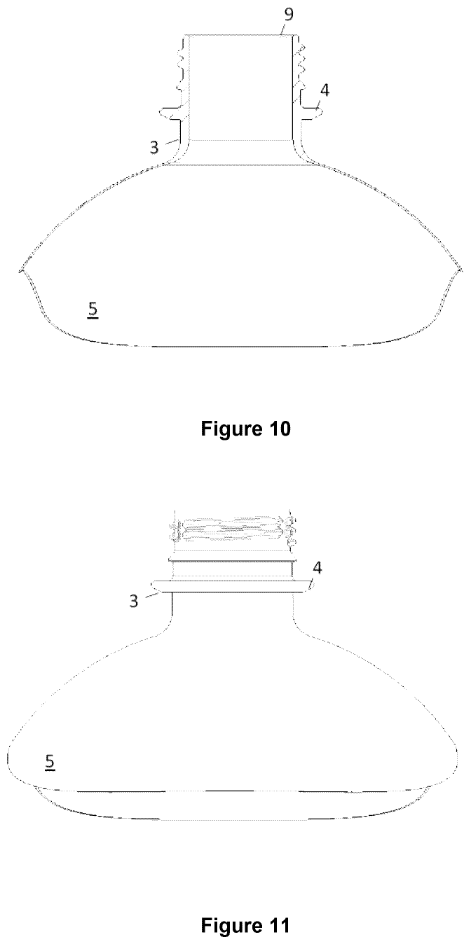

FIG. 8 shows an elevation cut away view of a top part of an example of the beverage container 1, which is in the form of a pressure bottle. The bottle 1 comprises a vessel 5 of blow moulded polyethylene terephthalate (PET) and closure 2, which is an assembly comprising a screw cap of polypropylene in which is disposed an optional seal 7 in the form of an induction foil seal. The vessel 5 has a neck 3 comprising an open end 6 that is optionally threaded and on which the closure 2 is threadedly attached. The induction foil seal 7 comprises polyester coated aluminium foil, and has a thickness of 100-150 μm, however other seals may be used as suitable and desired. The neck 3 comprises a circumferential flange 4 or integral collar. The closure 2 has a draught angle, extending outwardly, that is it is tapered such that it wider at its bottom end than its top end. The outer side surface 8 of the closure 2 is free of texturing, for example knurling, which facilitates the formation of a fluid seal with the apparatus 10.

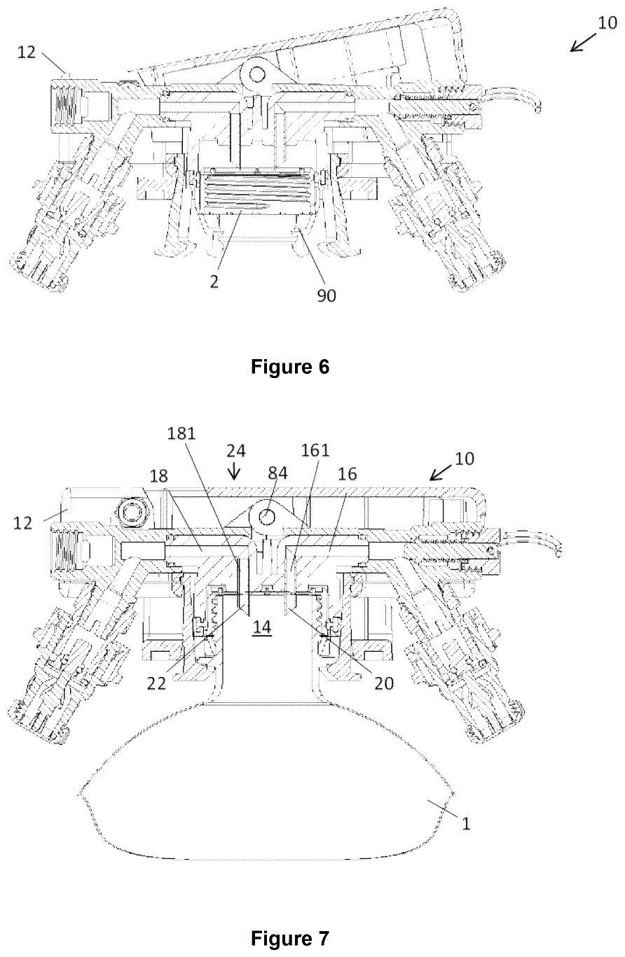

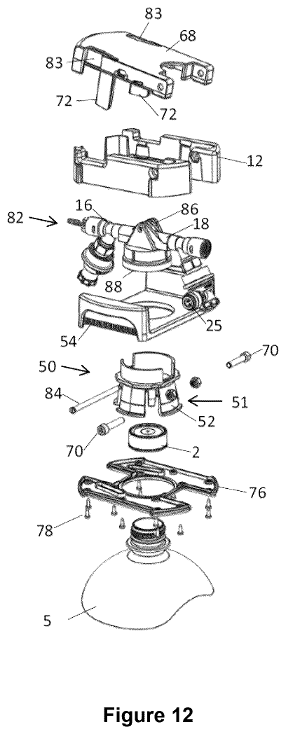

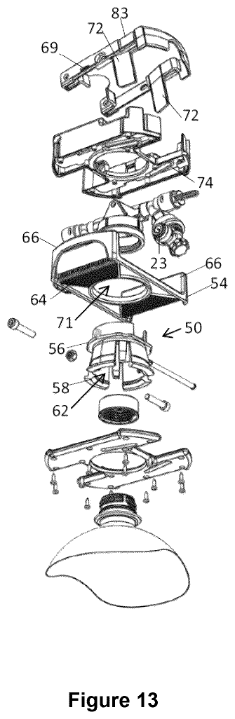

As understood with reference to FIG. 7, the apparatus 10 comprises a gas conduit 16 and a beverage conduit 18, each of which comprise sharp ended tubes 161,181 attached to the body 12. Each of the beverage conduit 18 and the gas conduit 16 comprising a piercing end 20,22 disposed within the beverage container receiving cavity 14. The piercing ends 20,22 are arranged to pierce the closure 2 as shown in FIG. 6 when the closure 2 is received within the beverage container receiving cavity 14. The piecing ends comprise stainless steel tube having 4 mm outer diameter and 0.5 mm thick side walls, although other materials such as polymer and other dimensions may be used as suitable and desired. When the piercing ends 20,22 have pieced the closure 2, they are disposed within the container 1 and so can provide gaseous communication and beverage communication with the interior of the beverage container 1. The gas conduit 16 can be connected to a gas tube in the form of a flexible or rigid gas tube (“gas line” or “carbon dioxide line” or “nitrogen line”, for example) and the beverage conduit 18 can be connected to a beverage tube in the form of a flexible or rigid beverage tube (“beverage line” or “beer line”, for example). The tubes may comprise vinyl, PVC or Ethylene-vinyl acetate (EVA), and are generally but not necessarily attached to fittings 23 and 25 (seen in FIGS. 12 and 13, for example) terminating the gas conduit 16 and beverage conduit 18. In use, the apparatus 10 is generally orientated such that the piercing ends 20,22 are upwardly orientated and the piercing ends 20, 22 are submerged in the beverage. The face 24 of the body 10 is arranged to be supported on a supporting surface—for example a bench top, floor or generally any suitable and desired surface—to orientate the piercing ends 20,22 upwardly. The centre to centre spacing of the piercing ends 20,22 of the gas conduit 16 and the beverage conduit 18 generally, but not necessarily, is 1 mm to 50 mm, for example 17 to 27 mm. The piecing ends 20,22 extend equally into the cavity. In alternative embodiments, however, piercing ends of the gas conduit and the beverage conduit extend by different amounts into the cavity.

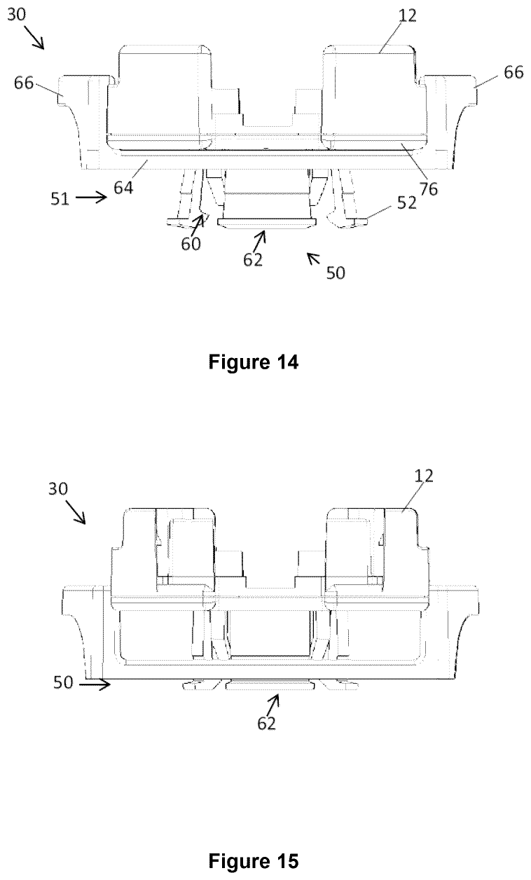

FIGS. 12 and 13 show exploded views of the apparatus 10, the vessel 5 and the vessel closure 2. The attachment of the beverage container 1 will now be described with reference to FIGS. 12 to 16. FIGS. 14 and 15 show, separated from the rest of the apparatus 10, a beverage container fastener 30 thereof. The beverage container fastener 30 is in the form of a chuck that can radially clamp the neck 3—or other suitable and desired part—of the beverage container 1 when the neck 3 is received by the beverage container receiving cavity 14. FIG. 14 shows the fastener 30 in the first configuration (“a configuration ready to receive the beverage container”), ready to receive the beverage container 1. FIG. 15 shows the fastener 30 in the second configuration (“a configuration for clamping the beverage container”). The beverage container fastener 30 comprises the body 12 comprising a collet 50. The body 12 comprises a separable body bottom plate 76 that fastens the collet 50 to the body. The bottom plate 76 is attached to the rest of the body 12 by fasteners 78 in the form of screws. The collet 50 comprises a tapered portion 51 comprising a plurality of resilient segments 52 that are spreadingly arranged. Each resilient segment 52 comprises axially spaced apart flanges 56,58. The tapered portion 51 of the collet 50 is disposed within and captured by a movably mounted camming collar 54, removal of which is prevented by interference by the spaced apart flanges 56,58. As seen in FIG. 13, the movable collar 54 comprises a collar plate 64 defining a collet receiving aperture 71, and optionally at least one peripheral handle 66, which may be attached to opposite sides to the collar plate 64 as in the presently described embodiment. Moving the collar 54 to the distal end of the tapered portion 51 of collet 50 constricts the tapered portion 51 whereby the resilient segments 52 move inwardly to constrict a beverage container receiving cavity opening 62 (“beverage container port”) defined thereby. To fasten the beverage container 1 to the apparatus 10, the beverage container 1 is inserted through opening 62, and collar 54 moved from a first position shown in FIG. 14 to a second position shown in FIG. 15. The collar 54 can be moved using, for example, the handles 66. As seen in FIG. 14, for example, the plurality of resilient segments 52 defines a plurality of jaws 60 comprising internal flanges behind which can be trapped the circumferential flange 4 of the neck 3 of the beverage container 1. The neck 3 can be inserted when the tapered portion is not constricted, but cannot be removed when the tapered portion is constricted, by interference by the plurality of jaws 60.

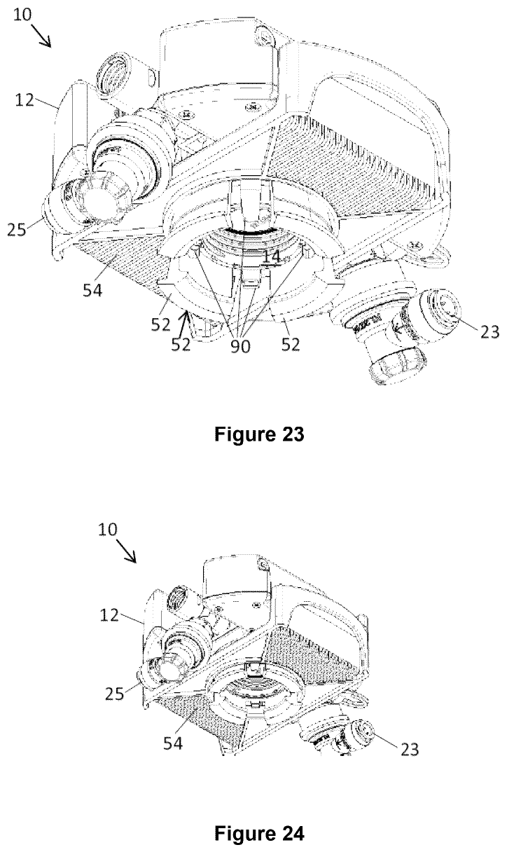

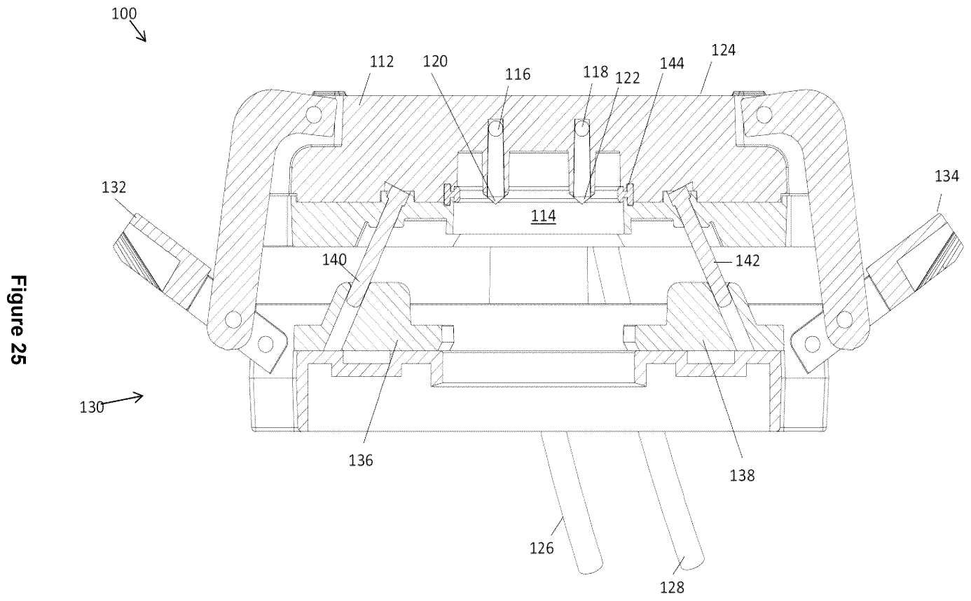

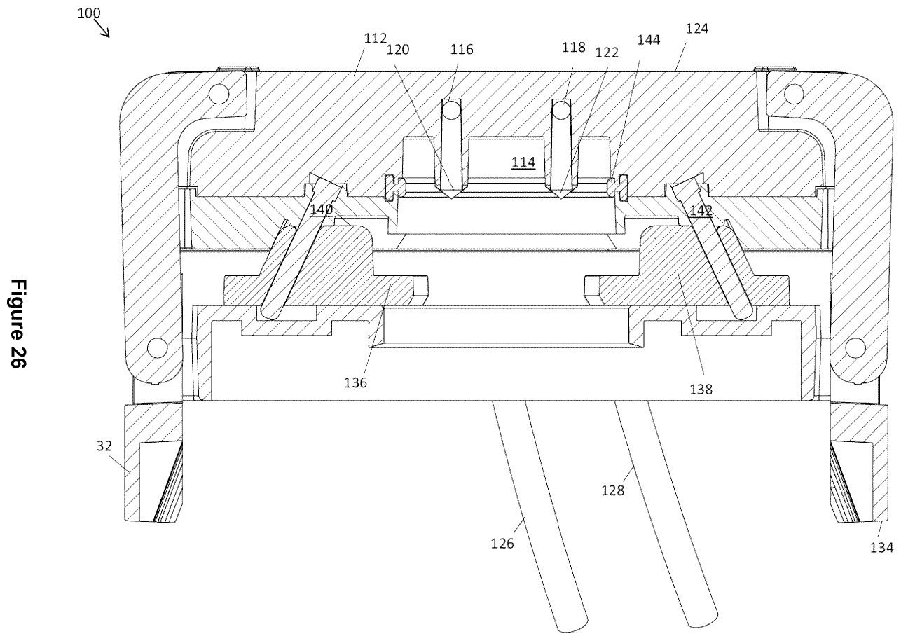

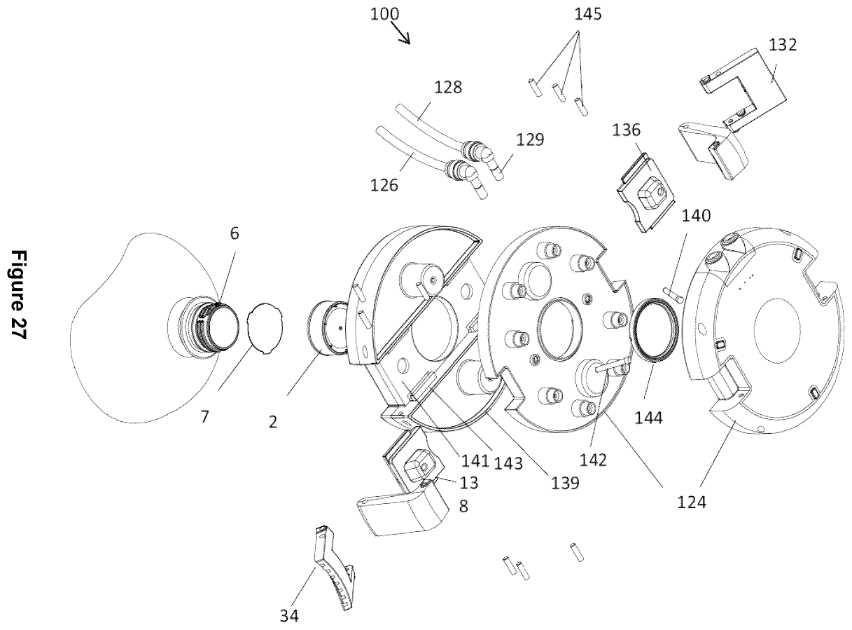

FIG. 23 shows a bottom isometric view of the apparatus of FIG. 1. Disposed within the beverage container receiving cavity 14 are a plurality of stops 90 attached to the collet 50 and configured to interfere with an upper surface of the beverage container collar 4. The plurality of stops 90 are circumferentially spaced apart such that can receive and capture the open end 6 therebetween. The distance between the plurality of stops 90 and the piercing ends 20,22 is greater than the distance between the collar 4 and the top of the cap 2, when actuator 68 is up and before the cap 2 is pierced. This prevents a beverage container from being inadvertently manually pushed into the piercing ends 20,22 which would result in unwanted piercing of the beverage container 1. The plurality of stops 90 locate the collar 4 relative to the plurality of jaws 60, such that the collar 4 can be trapped between the stops 90 and the plurality of jaws 60 with closure 2 in contact with the bottom wall 89 of the cup 88. Each of the plurality of stops 90 are inwardly inclined and resilient. Consequently, the grip of the plurality of stops 90 on the beverage container 1 increases with axial loading.

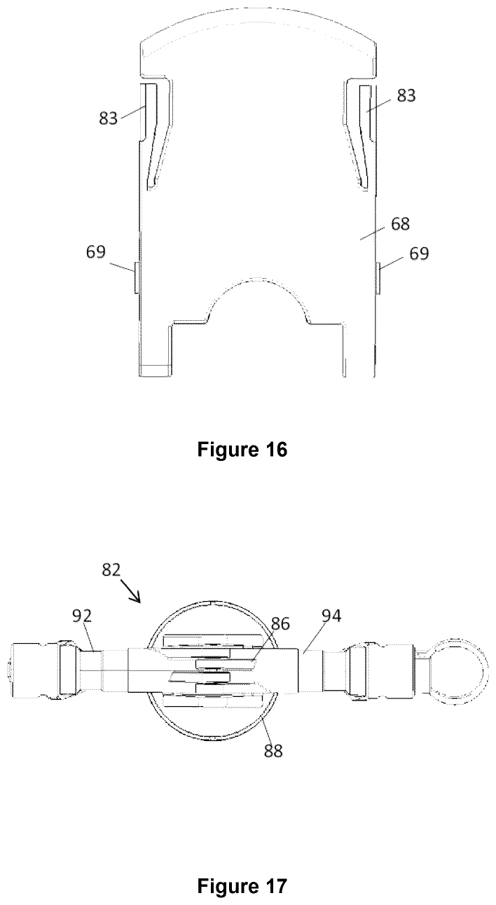

FIG. 16 show a plan view of an actuator 68, the operation of which can be understood with reference to FIGS. 2, 4, 12 and 13. The collar 54 is in this but not necessarily in all embodiments actuatable by operation of the actuator 68 in the form of a lever arm (“lever handle”) that is pivotably attached to the body 12 by at least one pivot pin 70. Actuator 68 comprises at least one collar engaging prong 72 in the form of a tab projecting towards the collar 54 and which passes through at least one prong aperture 74 defined by the body 12. A user operating the actuator 68 by pressing the lever arm inwardly can in this but not necessarily all embodiments cause the at least one collar engaging prong 72 to move the collar 54 along the tapered portion 51 of the collet 50, causing a camming action and a progressive constriction of the collet 50. In the case that the collar 54 is primarily moved using handles 66 instead of the lever arm 68, prongs 72 ensure that piecing is subsequent to moving the collar 54 with handles 66. A latch 80 comprising at least one resilient tab 83 of one of the body 12 and the actuator 68, and a resilient tab keeper of the other, enable latching of the actuator 68 and the body 12 to maintain the clamping of the beverage container 1 with a pressure seal. The resilient tab 83 comprises a flange that is received within the tab keeper. The latch 80 is releasable by deforming the at least one resilient tab 83. The actuator 68 comprises interference member 69 configured to cooperatively interfere with the body 12 to limit the lift of the actuator 68, which may improve safety in the case of a user trying to release a pressurised beverage container.

In a similar but alternative embodiment of a beverage dispensing apparatus 10, only one of the gas conduit 16 and the beverage conduit 18 have a piecing end. Within the cavity 14, a portion of the gas conduit 16 and the beverage conduit 18 are parallel and abutted or joined. The ends of the gas conduit 16 and the beverage conduit 18 are in this alternative embodiment longitudinally spaced apart.

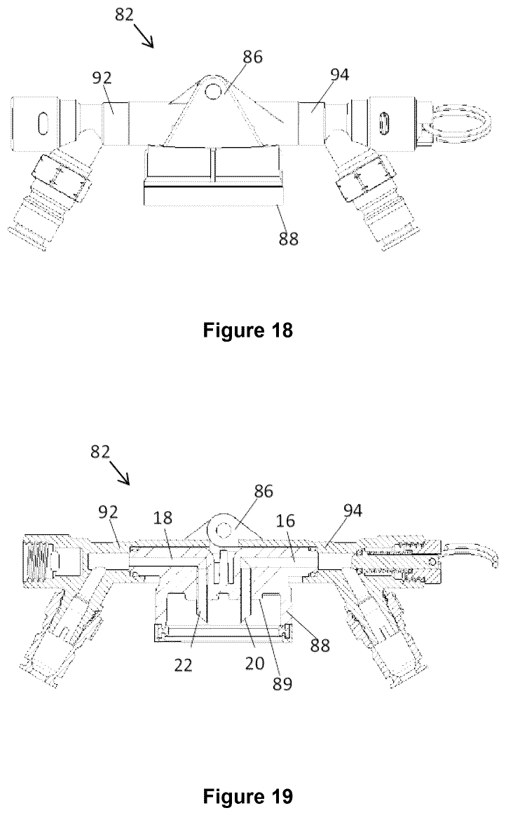

The closure 2 is pierced by the piecing ends 20,22 of the gas conduit 16 and beverage conduit 18 during the operation of the actuator 68 (“piercing actuator”). The apparatus 10 comprises a plunger 82 comprising the gas conduit 16 and the beverage conduit 18, the plunger 82 being shown in FIGS. 17 to 19. The plunger 82 comprises body 86 and attached limbs 92,94 respectively comprising the beverage 18 and gas 16 conduits. As shown in FIGS. 21 and 22, the plunger 82 is pivotably attached to the actuator 68 and inboard thereof. A pivot pin 84 attaches a plunger body 86 to the actuator 68, the pivot pin 84 passing through the plunger body 86 and apertures in the form of laterally extending slots defined by the actuator 68. The pivot pin 84 can translate along the slot so that there is no transverse translation of the plunger as it is longitudinally translated by operation of the actuator 68. Depending from the plunger body 86 is a cup 88 housing the piecing ends 20,22 of the gas conduit 16 and beverage conduit 18. The cup 88 is longitudinally movable within the collet 50, with the pivotal attachment of the plunger body 86 to the actuator 68 converting the rotational motion of the actuator 68 to translation of the cup 88 along a collet axis. This way, the piecing ends 20,22 can be moved to the closure 2 when received and pierce it.

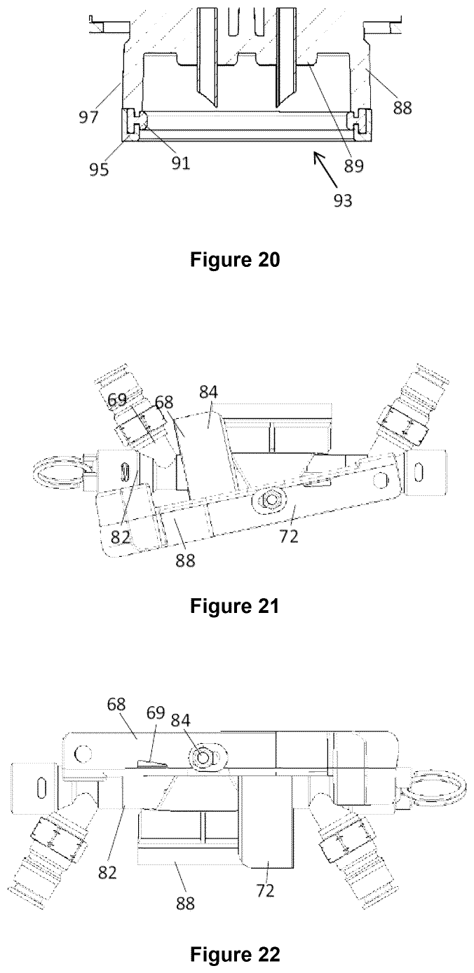

As shown in FIG. 20 for example, cup 88 comprises a pressure seal 91 in the form of ring seal adjacent cup opening 93. The ring seal 91 is in the form of a planar seal to allow the closure 12 to slidably engage therewith. The fluid seal 91 comprising an annular web intermediately attached to inner and outer rings, forming an I-shaped profile. The seal 91 is captured between capture ring 95 and cup side wall 97 attached thereto by an ultrasonic weld of the polymer parts 95,97. The inner diameter of the seal 91 is less than the outer diameter of the closure 2, providing around 0.3 mm of interference. Consequently, the seal is maintained as the closure is moved through the fluid seal 91 when the container 1 is being received or removed from apparatus 10. The draught angle of the closure 2 means that the seal improves as the container is moved into the container receiving cavity opening 62. The seal when formed prevents egress of beverage and effervescence, and the ingress of air which may spoil the beverage.

Apparatus 10 may comprise injected moulded polymer, cast metal, or generally any suitable material formed using any suitable process.

The beverage dispensing apparatus 10 and the beverage container 1 form a beverage dispensing system.

In the context of the above disclosure of apparatus 10, it will be appreciated a beverage in a sealed beverage container 1 can be dispensed using the apparatus 10. An embodiment of method of dispensing the beverage comprises sealingly fastening the beverage dispensing apparatus 10 to the beverage container 1. The method comprises piercingly inserting the gas conduit 16 and the beverage conduit 18 into the beverage container 1. In the case the beverage is carbonated, the beverage may be forced through the beverage tube 18 by the carbonation pressure. If the beverage is not carbonated or lightly carbonated, the flowing of a gas through the gas conduit 18 can force the beverage through the beverage tube 18. This can be enabled by connecting the gas conduit 16 to a source of effervescence gas, for example a cylinder comprising carbon dioxide and/or nitrogen.

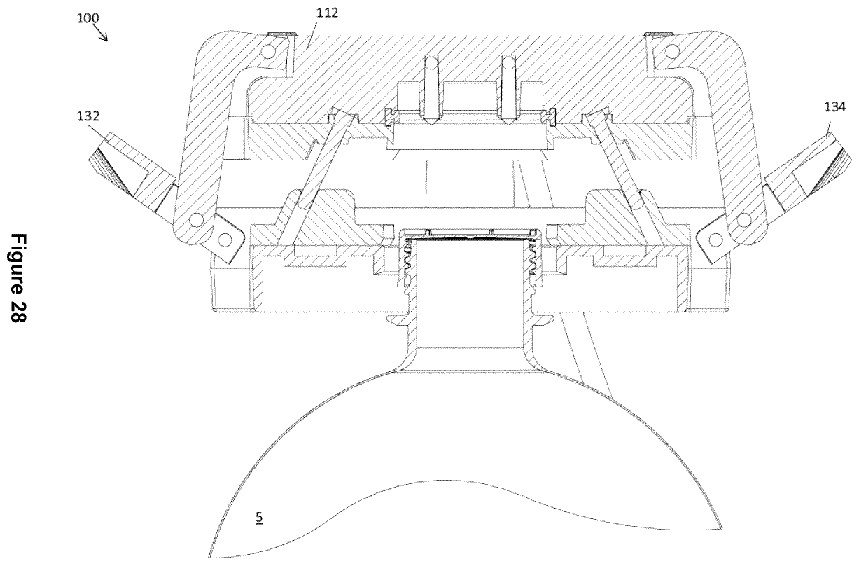

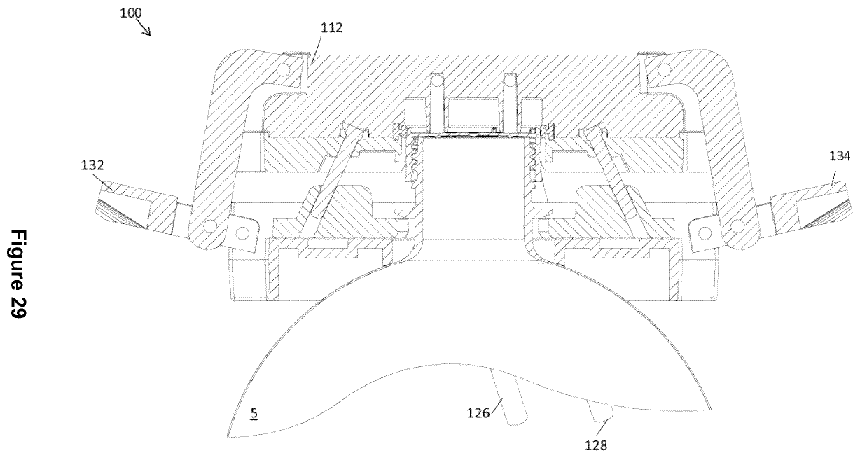

FIGS. 25 and 26 show cutaway elevation views of another embodiment of a beverage dispensing apparatus in two different configurations, the beverage dispensing apparatus being generally indicated by the numeral 100. The beverage dispensing apparatus 100 comprises a body 12 defining a beverage container receiving cavity 14.

FIG. 27 shows an exploded view of the apparatus 100 and the beverage container 1 to be received thereby. The apparatus 100 comprises a gas conduit 116 and a beverage conduit 118 each comprising a piercing end 120,122 and in the form of sharp ended tubes attached to the body 112 and disposed within the beverage container receiving cavity 114. The piercing ends 120,122 are configured to pierce the closure 2 when the closure 2 is received within the beverage container receiving cavity 114. When the piercing ends 120, 122 have pieced the closure 2, they are disposed within the container 1 and so provide gaseous communication and beverage communication with the interior of the vessel. The gas conduit 116 comprises a gas tube 126 in the form of a flexible gas tube (“gas line” or “carbon dioxide line”) and the beverage conduit comprises a beverage tube 128 in the form of a flexible beverage tube (“beverage line” or “beer line”). The flexible tubes may comprise vinyl, PVC or Ethylene-vinyl acetate (EVA), for example and are attached to fittings 129 in the form of push fittings attached to the body 112. In use, the apparatus 110 is orientated such that the piercing ends 120,122 are upwardly orientated and the piercing ends 120, 122 are submerged in the beverage. The surface 124 of the body 112 may be supported on a supporting surface—for example a bench top or floor—to orientate the piercing ends 120, 122 upwardly. The centre to centre spacing of the piercing end 120,122 of the gas conduit 116 and the beverage conduit 118 generally, but not necessarily, is 1 mm to 50 mm, for example 17 to 27 mm. The piecing ends 120,122 extend equally into the cavity. In alternative embodiments, however, piercing ends of the gas conduit and the beverage conduit extend by different amounts into the cavity. The closure 2 optionally comprises a tri-tab induction foil seal 7.

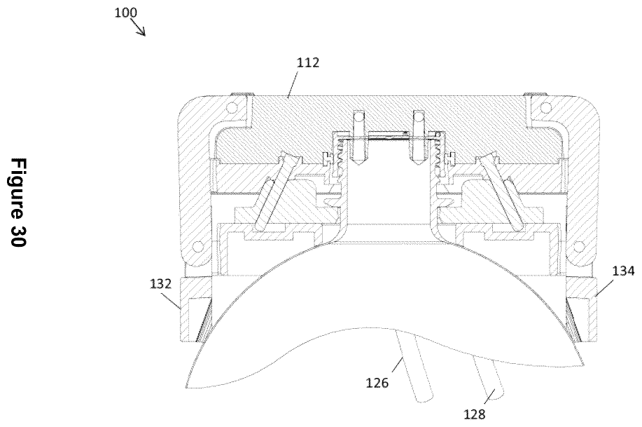

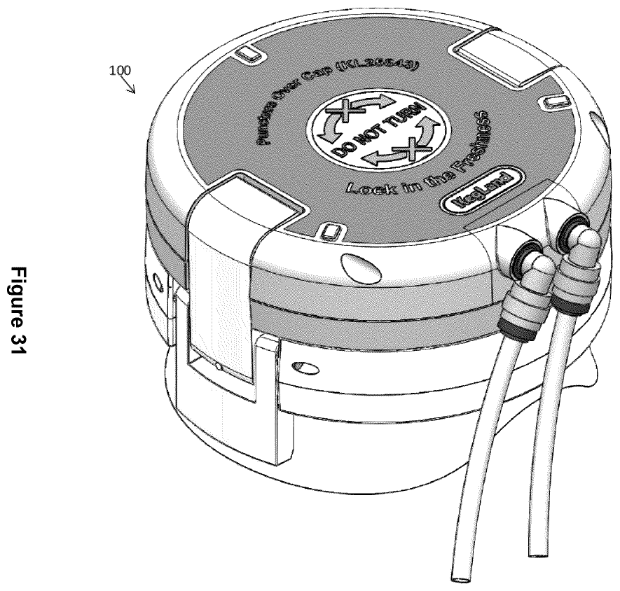

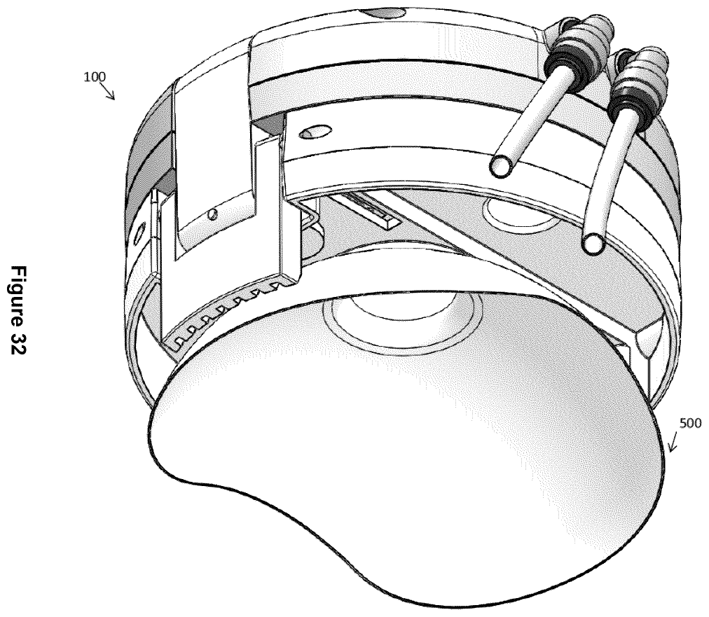

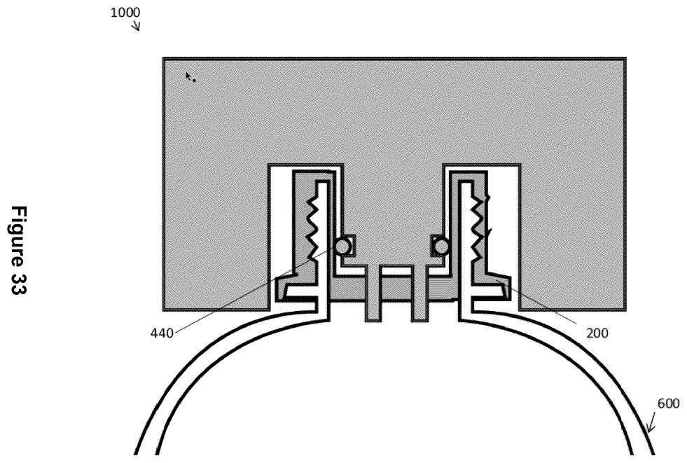

The apparatus 100 comprises a beverage container fastener 130 in the form of a mechanical fastener operationally coupled to the body 112 by handles 132,134 in the form of lever handles. The handles 132, 134 are part of a linkage comprising a plurality of pivotable attached elements (attached by pins 145 cooperatively arranged to provide a mechanical advantage. In FIG. 25, handles 132, 134 are in a disengaged position. In FIG. 26, the handles 132,134 are in an engaged position. The fastener 130 has at least one—in this particular embodiment two—movably mounted jaws 136,138. The jaws 136, 138 are slidable mounted to a fastener plate 139, and captured in a slot 141 thereof by a plurality of flanges 143. The movably mounted jaws 136,138 are mounted to move at an inclined angle relative to the piercing end 120, 122 of each of the gas conduit 116 and the beverage conduit 118. The movably mounted jaws 136,138 are mounted to guides 140,142 in the form of pins inclined relative to the piercing end of each of the gas conduit 116 and the beverage conduit 118. When the handles 132, 134 are moved from the disengaged to engaged position the fastener plate 139 is moved, and in turn the jaws 136,138 slide along guides 140, 142 to reduce their separation from each other and the separation of the jaws 136, 138 from the body 112. This motion can be used to linearly clamp the beverage container 1 between the jaws 136, 138 and draw the beverage container into the cavity 114. Consequently, the fastener 130 is operable to fasten the beverage container 1 when received in the beverage container receiving cavity 112. FIGS. 28 to 30 show a sequence of configurations of the faster 130 during fastening of the beverage container
to the apparatus 100 and moving the beverage container 1 into the cavity 114, and the closure 2 being pierced by the piercing ends 120,122. FIGS. 31 and 32 show isometric views of the apparatus 100 and the beverage container 1 received thereby.

The apparatus 100 comprises a seal 144 in the form of a ring seal disposed in the beverage container receiving cavity 114. In use the closure 2 is disposed in the ring seal 144 to form a fluid seal. The closure 2 has an outer wall that presents a smooth outer wall to facilitate formation of the fluid seal.

FIG. 33 shows a sectional view of an alternative embodiment of a dispensing apparatus 1000, wherein the seal 440 is disposed within the closure 200 to form the fluid seat, such that the closure 200 has an inner sealing surface.

Now that embodiments have been described, it will be appreciated that some embodiments may have some of the following advantages:
Embodiments may be compatible with recyclable and/or disposable beverage containers, and so may reduce the use of non-recyclable beverage containers that may be environmentally harmful.
Embodiments may be reusable.
Embodiments may be used with valveless beverage containers, which may cost less than beverage containers with valves.
Embodiments may enable the economical use of smaller disposable beverage containers, for example no more than 5 L or 10 L.
Embodiments may be used with packaging that is less expensive than cans or bottles.
When separated from an empty beverage container, residual pressure within the empty beverage container may be released, which may reduce the risk of injury.
A dip tube, which may be quite long and bulky, may not be required.
The piercing ends may be spaced apart to ameliorate gas introduced into the container by the gas conduit being drawn into the beverage conduit.

Variations and/or modifications may be made to the embodiments and examples described without departing from the spirit or ambit of the invention. For example:
Embodiments may be alternatively configured for closures other than screw caps. The closure may have a form other than a screw cap, for example a crimped crown seal or cap, a bayonet cap, a stopper in the form of a cork or generally any suitable form.
Embodiments may be alternatively configured for beverage containers that comprise a material other than PET, for example HDPE or other polymer, aluminium or another metal, or generally any suitable material as desired.
Embodiments may be alternatively configured for containers other than bottles, for example cans or kegs. The cavity, piercing ends and fasteners may be configured for the alternative embodiments.
Embodiments may use fittings other than push fittings, for example compression fittings or generally any suitable type of fitting.
The guides may take the form of a rails, pins or generally any other suitable and desired form.
One of the jaws may be fixed, in which case the piecing ends may be parallel to a guide.
The piercing ends may extend by different amounts into the beverage container and be separated by other distances.
The tubes may be rigid.
The chuck may take any suitable form, for example be screw rather than lever actuated, or have independently actuated jaws.
The fasteners may generally be any suitable and desired fasteners, including but not limited to screws, bolts and rivets.
The pivot pins may take any suitable and desired forms, for example plain pins and bolts.
A polymer seal or convection seal may be alternatively or additionally disposed in the screw cap.
A polymer part may be swapped for an equivalent metal part, or vice versa.
The fastener actuator may comprise a linkage comprising cascaded levers, for example, to provide mechanical advantage.

The present embodiments are, therefore, to be considered in all respects as illustrative and not restrictive. Reference to a feature disclosed herein does not mean that all embodiments must include the feature.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A beverage dispensing apparatus, comprising:
a body defining a beverage container receiving cavity;
a gas conduit and a beverage conduit, wherein at least one of the gas conduit and the beverage conduit comprise a piercing end disposed within the beverage container receiving cavity; and
a beverage container fastener comprising a fluid seal, the beverage container fastener being operable to sealingly fasten to a sealed beverage container when received in the beverage container receiving cavity.

2. A beverage dispensing apparatus defined by claim 1, wherein the beverage container fastener comprises a chuck for beverage container clamping.

3. A beverage dispensing apparatus defined claim 2, wherein the chuck comprises a movably mounted collet camming collar and a collet disposed therein.

4. A beverage dispensing apparatus defined by claim 1, comprising a user operable piercing actuator operationally coupled to the at least one piercing end.

5. A beverage dispensing apparatus defined by claim 4, wherein the user operable piercing actuator comprises at least one lever.

6. A beverage dispensing apparatus defined by claim 4, wherein the user operable piercing actuator comprises at least one collet camming collar engaging prong.

7. A beverage dispensing apparatus defined by claim 4, wherein the user operable piercing actuator is latchable.

8. The beverage dispensing apparatus defined by claim 1, wherein at least one piecing end is movable towards an opening of the beverage container receiving cavity.

9. The beverage dispensing apparatus defined by claim 1, and having a first configuration ready to receive the beverage container and a second configuration for attaching the beverage container.

10. A beverage container defined by claim 1, wherein the fluid seal comprises a fluid pressure seal.

11. A beverage container defined by claim 10, wherein the fluid pressure seal is a planar fluid pressure seal.

12. A beverage dispensing apparatus defined by claim 1, wherein the beverage container fastener is operable to move the beverage container into the beverage container receiving cavity.

13. A beverage dispensing apparatus defined by claim 12, wherein the beverage container fastener comprises a movably mounted jaw.

14. A beverage dispensing apparatus defined by claim 13, wherein the movably mounted jaw is mounted to move at an inclined angle relative to the piercing end of each of the gas conduit and the beverage conduit.

15. A beverage dispensing apparatus defined by claim 14, wherein the movably mounted jaw is mounted to a guide inclined relative to the at least one piercing end.

16. A beverage dispensing system comprising the beverage dispensing apparatus of claim 1 and the beverage container.

17. A beverage dispensing system defined by claim 16, wherein the beverage container comprises a closure comprising a perimeter wall presenting a smooth outer surface.

18. A beverage dispensing system defined by claim 17, wherein the beverage container comprises a tapered closure and the beverage container receiving cavity is for the closure.

19. A beverage container comprising a closure comprising a perimeter wall presenting a smooth outer surface.

20. A method of dispensing a beverage, the method comprising the steps of:
sealingly fastening a beverage dispensing apparatus defined by any one of the claims 1 to 15 to a beverage container;
piercingly insert the gas conduit and the beverage conduit into the beverage container without removal of the closure.
